(19) United States
(12) Patent Application Publication
(10) Pub. No.: US 2011/0304480 A1
(43) Pub. Date: Dec. 15, 2011

(54) APPARATUS FOR LOCATING ONE MOORING IN A FIELD OF MOORINGS

(76) Inventors: Frank Doria, Bayville, NY (US); William Finn, Bayville, NY (US)

(21) Appl. No.: 12/796,968

(22) Filed: Jun. 9, 2010

(51) Int. Cl. G08B 23/00

(52) U.S. Cl. 340/984

(57) ABSTRACT

An apparatus and system for locating a mooring in a field of moorings is provided. The system includes a receiver either releasably attached to or integrally formed with a mooring, and a remote transmitter. The receiver is configured to include one or more visual and/or audible indicators. In other implementations, the receiver is configured to detect the user's boat when the boat is within a predetermined vicinity of the mooring and automatically activate its indicators in response to the vicinity detector.

### BACKGROUND

1. Technical Field

The present invention relates to boating. More particularly, it relates to a system and method for locating a mooring in a field of moorings.

2. Description of Related Art

In marine environments, and particularly in a leisure boating environment, the use of mooring fields is very common for accommodating the seasonally anchoring of many boats in a small area. A mooring is generally rented or owned by a boater, and is used to anchor the boat when not in use, during the boating season.

Anyone who has had the experience of returning to their mooring at times when visibility is poor (e.g., during dusk/darkness, fog, etc) understands that they can often be difficult to locate. This is especially true when there are many empty moorings in a mooring field when returning to the same.

### SUMMARY OF THE INVENTION

It is therefore an aspect of the invention to provide an apparatus for locating one mooring in a field of moorings.

This and other aspects are achieved in accordance with an implementation of the invention where the mooring locator system includes a transmitter capable of transmitting an activating radio signal; and a remote mooring receiver capable of being releasably attached to the mooring and having at least one indicator thereon capable of being activated in response to a received activating radio signal, said indicator enabling a carrier of the transmitter to locate a single mooring in a field of moorings.

In another implementation, the mooring locator system for identifying one of a plurality of moorings in a field of moorings includes a transmitter device positioned on a boat and configured to transmit a wireless signal having a predetermined transmission range, and a vicinity detector positioned at the mooring and having one or more lights configured to illuminate the mooring in response to the received wireless signal; wherein said vicinity detector has a predetermined detection range.

9. A mooring locator system for identifying one of a plurality of moorings in a field of moorings, the mooring locator system comprising:

a transceiver positioned on a mooring and configured to transmit a wireless signal having a predetermined transmission range, the transceiver having one or more lights configured to illuminate the mooring; and

a vicinity detector positioned on a boat and configured to receive the wireless signal from the transceiver and in response transmits an activation signal to the transceiver to activate the one or more lights to illuminate the mooring in response to the received wireless signal; wherein said vicinity detector has a predetermined detection range up 100 feet.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is an exemplary view of one known mooring configuration generally used for power boats;

FIG. 2 is another exemplary view of another known mooring configuration generally used for sailboats;

FIG. 3a is an example of a modified mooring with the mooring locator according to an implementation of the invention;

FIG. 3b is an example of a modified mooring with the mooring locator according to another implementation of the invention;

FIG. 3c is an example of a modified mooring with the mooring locator according to another implementation of the invention;

FIG. 3d is an example of a modified mooring with the mooring locator according to another implementation of the invention;

FIG. 4a is a plan view of an exemplary implementation of the mooring locator according to the invention;

FIG. 4b is a plan view of another exemplary implementation of the mooring locator according to the invention;

FIGS. 5 and 6 are schematic views of the mooring locator according to another implementation of the present invention;

FIGS. 7a and 7b show another embodiment of the mooring locator according to a further implementation of the invention; and

FIG. 8 is a block diagram of a transmitter/receiver implementation of the mooring locator according to the invention.

### DETAILED DESCRIPTION

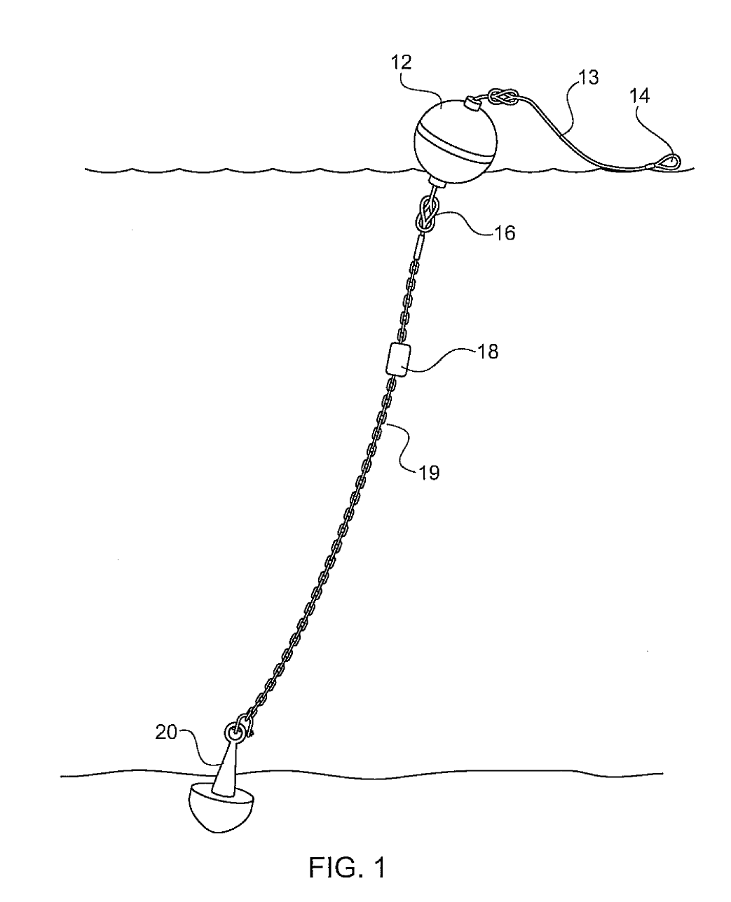

Referring to FIG. 1, there is shown an exemplary mooring system 10a where the mooring 12 is connected 16 to a rope/chain 19 which is connected to anchor system 20 at the bottom of the water within which the mooring 12 is located. In some implementations, the rope 19 may include a weight 18. In other implementations, the chain 19 is heavy enough so that the weight 18 is not required. The mooring 12 includes a mooring rope 13 with a boat shackle 14 for connection to the boat.

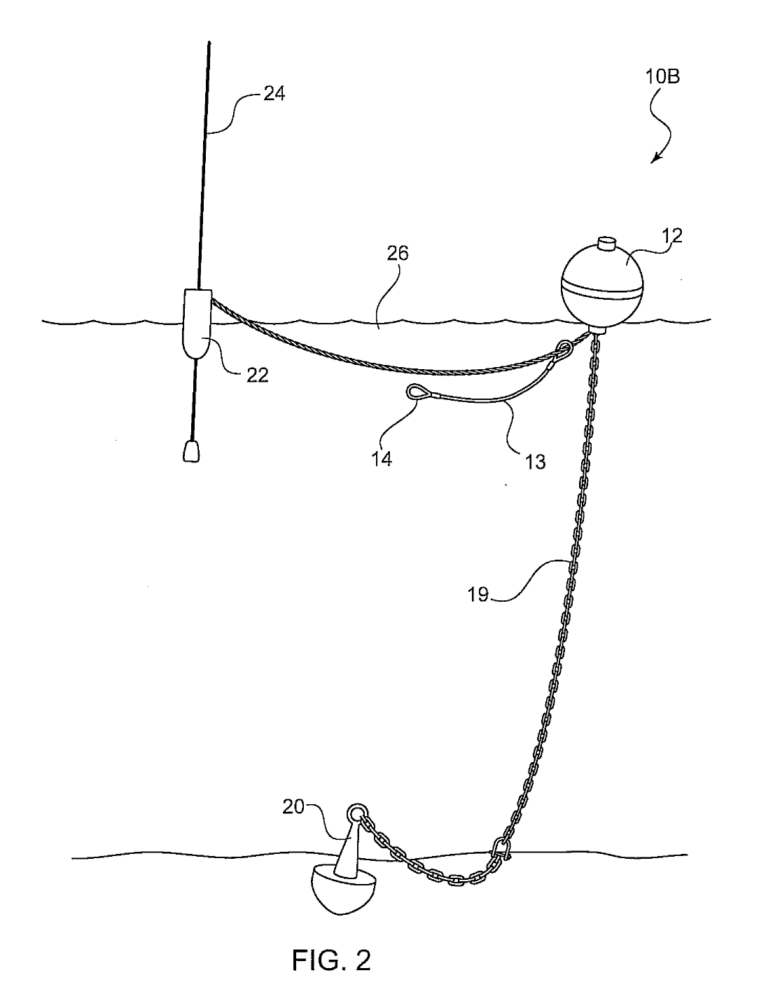

FIG. 2 shows another exemplary mooring system that is often used in a sailboat mooring field. In this example, a safety buoy 22 is connected to the mooring 12 by a line 26. The safety buoy generally includes a grab-pole 24 which allows the boater to grab the same without having to reach down to the water level to access the mooring. The grab-pole 24 is generally made of fiberglass. In this embodiment, the user would use the grab pole 24 to pull the mooring 12 toward the boat. Once within reach, the user would connector the mooring to the boat via shackle 14 and mooring rope 13.

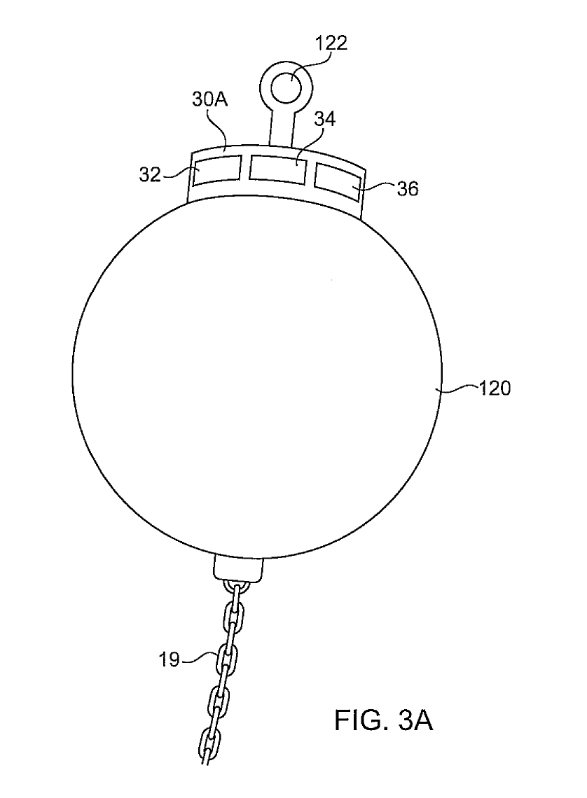

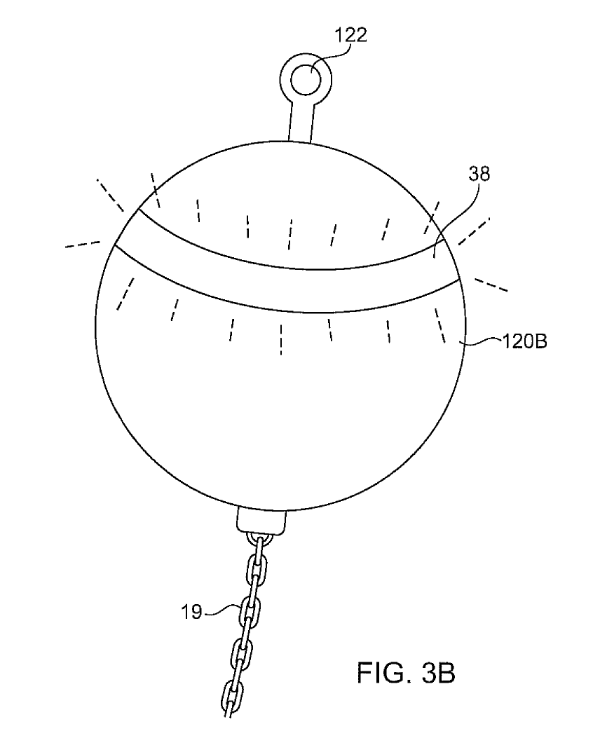

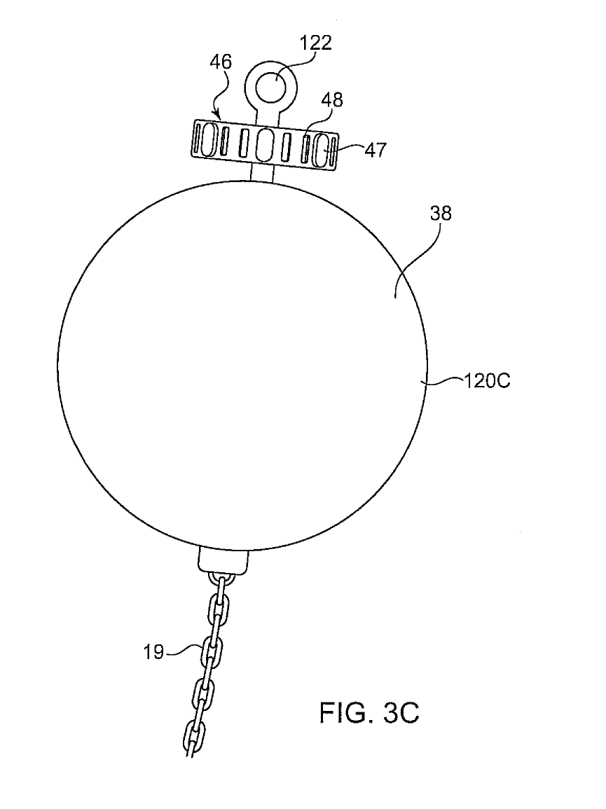

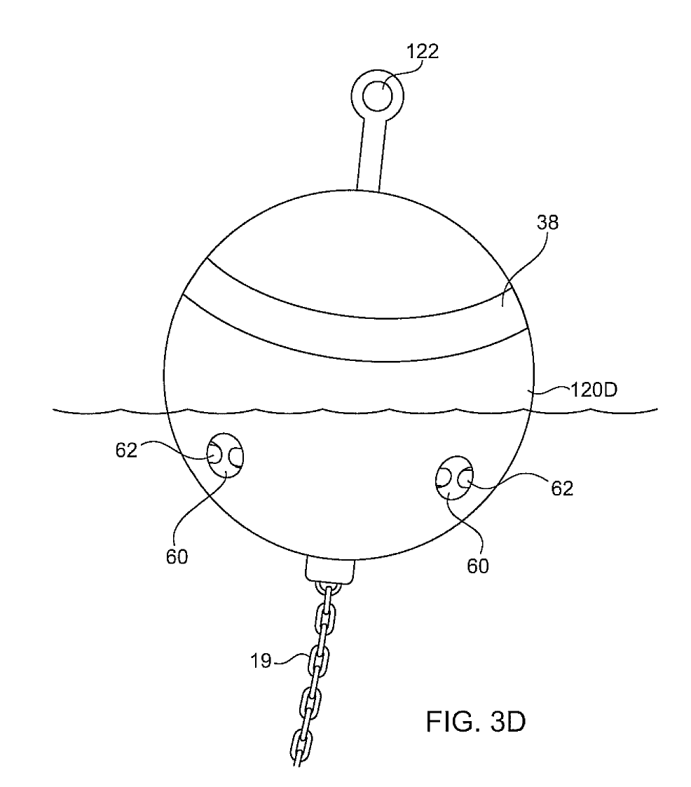

FIG. 3a shows an example of a mooring 120a according to an implementation of the present invention. In this implementation, a receiver 30a is either removably attached to the top of the mooring (e.g., by connection to the mooring shackle 122) or alternatively can be integrally formed with the mooring 120a and mooring shackle 122 during manufacture of the same. The receiver 30a can include one or more visual indicators 32, 34 and 36, and may also include one or more audible indicators (not shown).

FIG. 3b shows another example of a mooring 120b showing a light band 38 integrated therein during the manufacture of the mooring. In this implementation, the receiver electronics are contained within the mooring 120 during manufacture and the light band 38 can consist of any color or style depending on the design choice.

FIG. 3c shows yet another implementation of a mooring 120c having a locator 46 rotatably mounted on the shaft of the mooring hook 122. In this implementation, the locator 46 includes air fins 48 and one or more lights 47. The air fins 48 facilitate the rotation of the locator 46 and this rotation can configured to include wind driven electric generator to assist in the charging of the receiver battery power source. In another implementation, this wind generation concept can be applied to the mooring 120b of FIG. 3b and implemented during manufacture of the same.

FIG. 3d shows a further implementation of the mooring 120d which includes one or more water passages 60 therethrough. In this implementation, each water passage 60 includes one or more miniature water turbines 62 which generate electric power when moved by the water moving through the water passage 60. The water turbines 62 would be moved in response to the changing water currents either naturally or caused by boating traffic. In this implementation, the electric power generated by the water turbines 62 would be used to assist in the charging of the receiver battery power source.

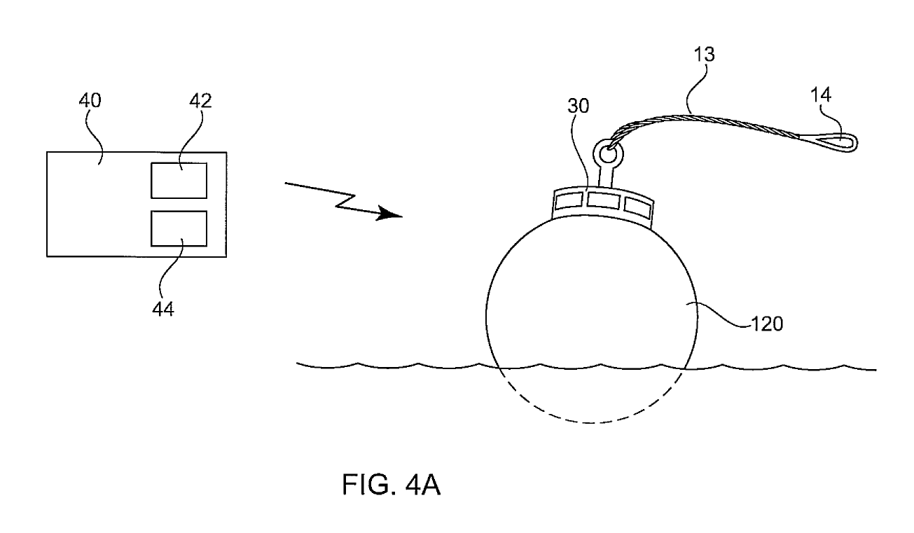

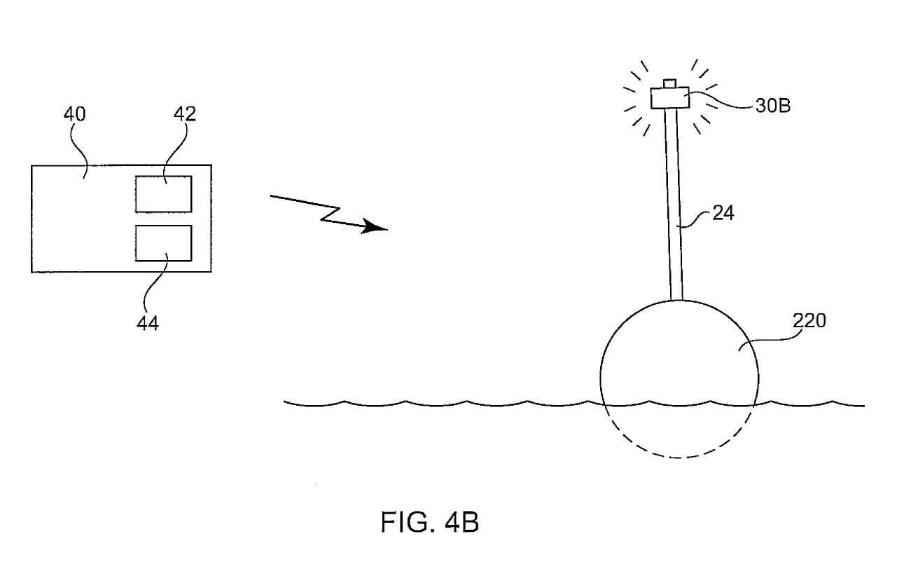

FIG. 4a shows one implementation of the mooring 120 with the receiver 30. A remote transmitter 40 includes one or more buttons 42, 44 for selectively transmitting an activating radio signal. Thus, in this implementation, when a boater is approaching their mooring field, they can press the appropriate button 42, 44 and send the activating radio signal to the receiver 30. In response, the receiver 30 will activate one of the indicators (e.g., lights or audible sounds, or both) depending on the desired application and setup. In one implementation, one of the buttons on the remote transmitter 40 includes a turn off button (e.g., 44) which is configured to send a deactivating radio signal to the receiver 30. In one example this deactivation can be used when the user has located their mooring.

FIG. 4b shows another implementation of the present invention where the remote receiver 30B is releasably connected to the grab pole 24 of the safety buoy 220.

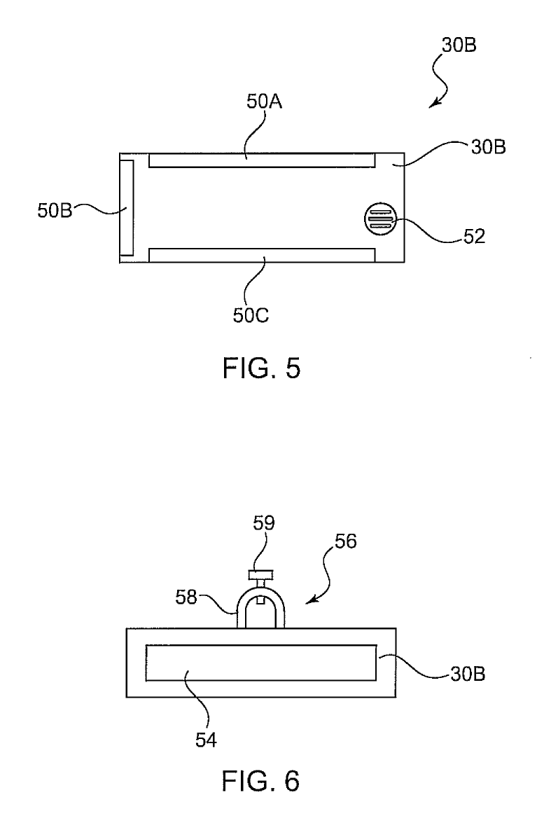

FIGS. 5 and 6 show an example of the receiver 30B according to the present invention. In this example, the receiver 30b includes one or more lights 50a, 50b, 50c in which one or more are configured to be activated in response to the received activating radio signal. In other contemplated implementations one or more lights 50 are configured to be directed downward toward the mooring itself and the surrounding water within which the mooring is located. In this implementation, the visual indicators 50 will not interfere with other boaters who may be near the receiver 30 when activated.

Also as shown, the receiver 30B can include an audible indicator 52 which provides some form of audible sound (either constant or intermittent) in response to the radio activating signal. As explained above, the user may selectively activate one or the other of the visual or audible indicators, respectively, or both depending on their desired use.

FIG. 6 shows an example of a connection system 56 for the receiver 30b to be connected to the grab pole 24 of a safety buoy, or even the mooring shackle 122 A U-hook 58 can be either integrated into the receiver as shown, and includes a tightening thumb screw 59 to secure the U-hook (and thereby the receiver) to the mooring shackle 122 or grab pole 24.

In one implementation, the receiver 30 can include one or more solar collectors 54 for the purpose of maintaining the battery charge on the batteries contained within the receiver 30.

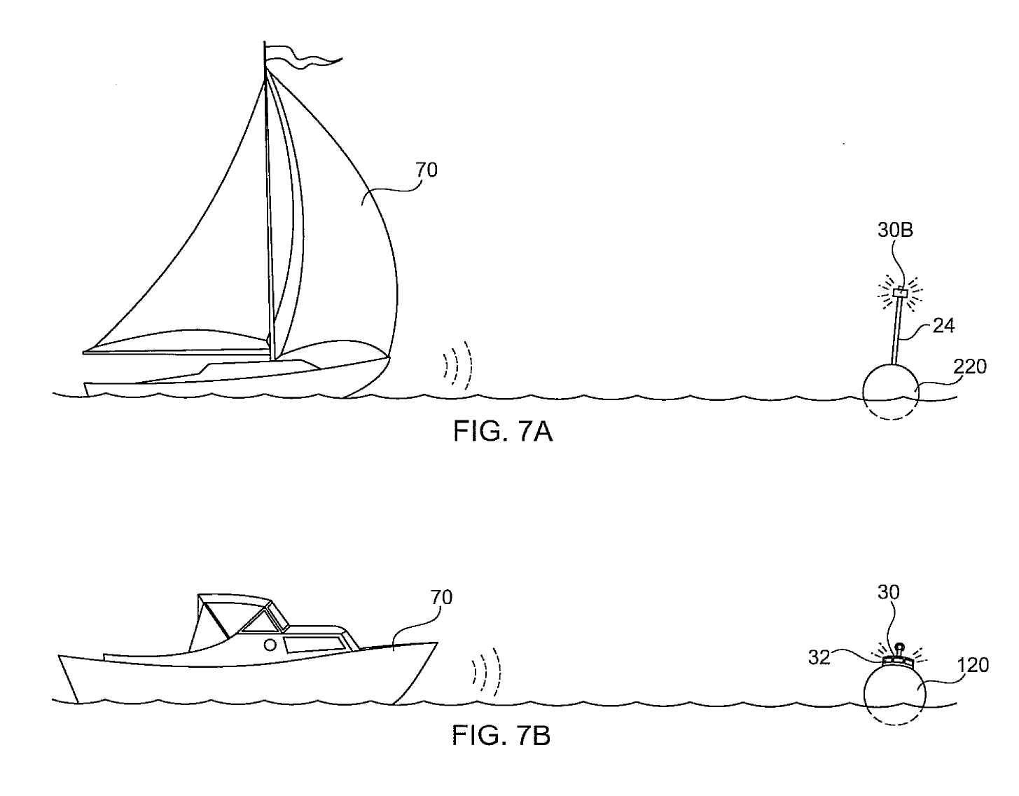

FIGS. 7a and 7b show an alternative implementation of the invention where the transmitter 40 and/or receiver 30 can is replaced with a vicinity transmitter and/or receiver, respectively. In this manner, when the user's boat 70 carrying the vicinity transmitter enters some predetermined range of distance to the receiver 30, the receiver 30 is automatically activated without requiring the user to press any buttons or otherwise. In this configuration, when the boat 70 comes within a certain distance from its mooring and emits its locator signal, the mooring receiver 30 will automatically activate and assist the boater in locating the same.

In another contemplated implementation, the receiver 30 can be an RFID type device that is activated when and RFID activation signal sent from the boat is received. Once received the RFID device will activate the indicators (visual or audible). Alternatively, the mooring can be fitted with a n RFID transmitter capable of detecting the presence of an RFID device located on the boat. Thus, in this implementation, when the boat is within the distance range of the RFID transmitter disposed at the mooring location, the RFID device on the boat will be triggered letting the mooring RFID device know the boat is approaching and enable the mooring RFID circuit to activate the location indicator.

Although some embodiments are described in the context of a retro-fit device for existing moorings, it will be understood by those of skill in the art that the above described principles may be applied at the manufacturing stage of the moorings and/or boats such that each are equipped with the mooring locator capability of the present invention.

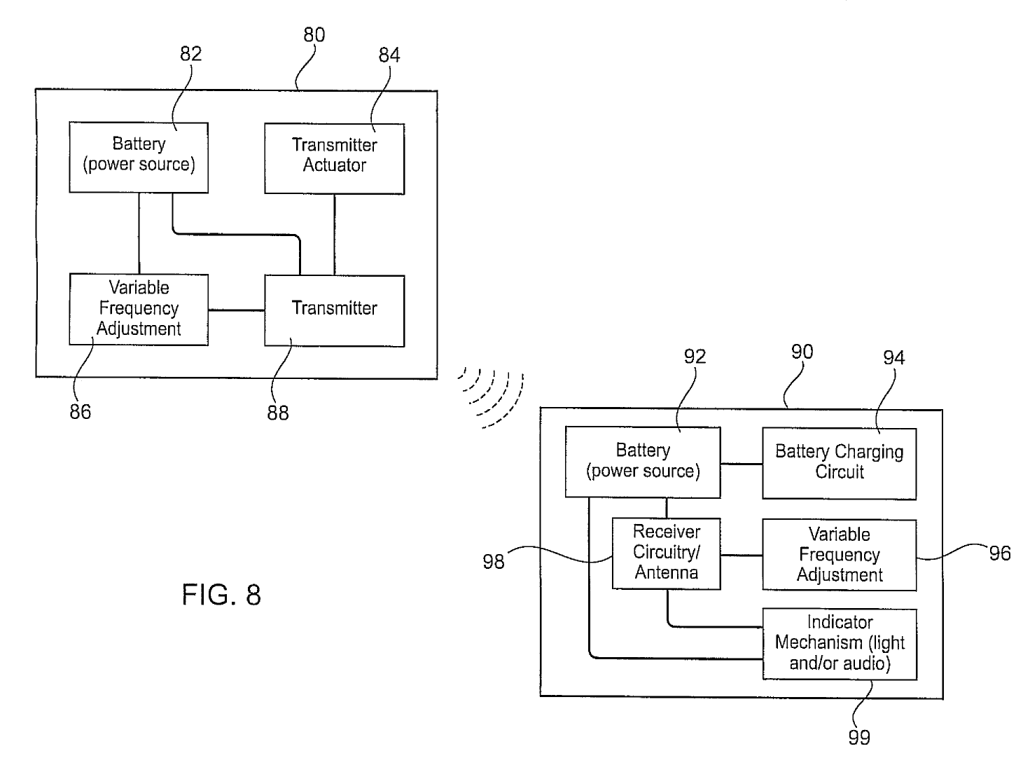

FIG. 8 shows a block circuit diagram of a transmitter 80 and receiver 90 according to an implementation of the invention. The transmitter 80 includes a batter power source 82 that supplies power to the circuit elements such as the transmitter and the variable frequency adjustment 86. When the user activates the transmitter actuator 84 (e.g., a button or switch on the transmitter 80), the transmitter will emit a wireless activation signal having predetermined distance range, for example up to 5000 feet.

The receiver 90 includes a battery/power source 92 having a battery charging circuit 94 in signal communication therewith. The receiver circuitry 98 includes an antenna and is connected to the variable frequency adjustment circuit 96 and indicator mechanism 99. Thus, when the receiver 90 receives the activation signal, the indicator mechanism 99 is activated, thus providing the boater with the location of their mooring.

Those of skill in the art will recognize that the variable frequency adjustment circuits 86 and 96 can be any known type of circuit capable of enabling many of the mooring locator systems to operate in the same range without interfering with each other and without causing false indications by activating the wrong indicator on the wrong mooring.

Although FIG. 8 shows the concept of a separate transmitter 80 and receiver 90, as described above, in the vicinity detector implementations, the boat or mooring could have a transmitter, and the mooring or boat, respectively, would have a combined receiver/transmitter (e.g. transceiver) configured to respond to the signals sent from the transmitter when the transmitter has come within a predetermined range of its corresponding receiver. For example, this range can be adjustable and configured to be from 2-300 feet. In this vicinity detector implementation, the “receiver” is preferably a transceiver and is referred to herein as a “vicinity detector”.

In yet another implementation, it is herein contemplated that the mooring 12 includes a receiver capable of being called using a telephone, for example a cell phone. Thus, in this implementation, when the boater is approaching their mooring field, they can simply call a phone number that is designated to the receiver contained within (or attached to) the mooring and in response to the receipt of a telephone call itself, or other input by the user (e.g., some alphanumeric code), the receiver will activate the mooring indicator mechanism.

Other implementations of the mooring locator system of the present principles may use a geographic positioning system (GPS).

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A mooring locator system comprising:
a transmitter capable of transmitting an activating radio signal; and
a remote mooring receiver capable of being releasably attached to the mooring and having at least one indicator thereon capable of being activated in response to a received activating radio signal, said indicator enabling a carrier of the transmitter to locate a single mooring in a field of moorings.

2. The mooring locator of claim 1, wherein the at least one indicator comprises a light configured to illuminate the mooring.

3. The mooring locator of claim 1, wherein the at least one indicator comprises an audible sound emitted from the receiver.

4. The mooring locator of claim 1, wherein the transmitter and receiver further comprise variable wireless frequency adjustment so as to allow for many mooring locators to be used without interfering with each other in the field of moorings.

5. The mooring locator of claim 1, wherein the remote mooring receiving further comprises:
a power source; and
charging means for maintaining a minimum operating power of the power source.

6. The mooring locator of claim 5, wherein the charging means comprises solar charging.

7. The mooring locator of claim 5, wherein the charging means comprises wind generators.

8. A mooring locator system for identifying one of a plurality of moorings in a field of moorings, the mooring locator system comprising:
a transmitter device positioned on a boat and configured to transmit a wireless signal having a predetermined transmission range; and
a vicinity detector positioned at the mooring and having one or more lights configured to illuminate the mooring in response to the received wireless signal; wherein said vicinity detector has a predetermined detection range up 200 feet.

9. A mooring locator system for identifying one of a plurality of moorings in a field of moorings, the mooring locator system comprising:
a transceiver positioned on a mooring and configured to transmit a wireless signal having a predetermined transmission range, the transceiver having one or more lights configured to illuminate the mooring; and
a vicinity detector positioned on a boat and configured to receive the wireless signal from the transceiver and in response transmits an activation signal to the transceiver to activate the one or more lights to illuminate the mooring in response to the received wireless signal; wherein said vicinity detector has a predetermined detection range up 200 feet.
